(19) United States
(12) Patent Application Publication
(10) Pub. No.: US 2025/0219242 A1
(43) Pub. Date: Jul. 3, 2025

(54) FLAMMABLE ELECTROLYTE VAPOR TRAPPER, AND BATTERY PACK WITH FLAMMABLE ELECTROLYTE VAPOR TRAPPER

(71) Applicant: GM GLOBAL TECHNOLOGY OPERATIONS LLC, Detroit, MI (US)

(72) Inventors: Meinan HE, Birmingham, MI (US); William Reginald Collin, Dearborn, MI (US); Xingcheng Xiao, Troy, MI (US); Robert Steven Conell, Sterling Heights, MI (US); William Osad, Macomb, MI (US)

(21) Appl. No.: 18/396,961

(22) Filed: Dec. 27, 2023

(51) Int. Cl. H01M 50/392; H01M 50/383; H01M 50/417

(52) U.S. Cl. CPC H01M 50/392; H01M 50/383; H01M 50/417

(57) ABSTRACT

An improved battery pack of the type comprising an enclosure containing a plurality of battery cells having a flammable volatile electrolyte component. The improvement comprises a trapper material that absorbs the volatile flammable electrolyte component disposed inside the enclosure of the battery pack to absorb flammable volatile electrolyte component that leak from the cells in the enclosure.

### FIELD

This disclosure relates to a flammable electrolyte vapor trapper, and in particular to a battery pack with a flammable electrolyte vapor trapper.

### INTRODUCTION

Many battery systems employ electrolytes with volatile flammable components. Although rare, if a sufficient quantity of these components were to leak from the cells in which they are employed, it could increase the risk of fire.

Embodiments of the present disclosure provide a vapor trapper for trapping flammable electrolyte vapor in a battery back, and in particular to a battery pack with such a vapor trapper.

### SUMMARY

According to a first embodiment of this disclosure, an improved battery pack of the type comprising an enclosure containing a plurality of battery cells having at least one flammable volatile electrolyte component is provided. The improvement comprises a trapper material that absorbs the volatile flammable electrolyte component that might leak from the batter cells disposed inside the enclosure of the battery pack.

The cells may be any type of battery cell that employs a volatile, potentially flammable electrolyte materials, including, for example, Li/NCMA (nickel, cobalt, manganese, aluminum) cells with an electrolyte comprising fluoroethylene carbonate (FEC), dimethyl carbonate (DMC), and LiPF₆, or graphite/NCMA (nickel, cobalt, manganese, aluminum) cells with an electrolyte comprising ethylene carbonate (EC), ethyl methyl carbonate (EMC), and LiPF₆.

The cells of the battery pack may be arranged in a plurality of modules, and the trapper material can be disposed in foam separators between the cells in each module. Alternatively or in addition, trapper material can be disposed in a layer in the bottom of the disclosure, under the plurality of battery cells. Alternatively, or in addition the trapper material can be disposed in spaces in the enclosure not occupied by battery cells. Alternatively, or in addition the trapper material can be disposed in on the exterior of the battery cells.

In some embodiments, the trapper material is disposed in a trapper bed in a replaceable module that circulates atmosphere inside the enclosure through the trapper bed.

The trapper material can comprise any of a variety of materials that absorb volatile, flammable substances, for example a hydrophobic, high surface (>40 m²/g) area thin (<5 mm) polyolefin film, such as polyethylene or polypropylene. The trapper material can comprise a hydrophobic zeolite, silica gel, activated alumina with high specific surface area (>40 m²/g) and decorated with hydrophobic functional groups, a polarized polymeric resin that selectively adsorbs polar solvents; metal-organic frameworks (MOFs), clays, such as montmorillonite and bentonite, or highly porous (50%-99%), high surface area (>40 m²/g) carbon-based adsorbent (graphitized carbon, carbon molecular sieves or activated carbon).

According to another embodiment of this disclosure, a battery pack comprising an enclosure, a plurality of battery cells having at least one flammable volatile electrolyte component, and a trapper material disposed in the enclosure that that absorbs the at least one volatile flammable electrolyte component from the batter cells. disposed inside the enclosure of the battery pack.

The cells of the battery pack may be arranged in a plurality of modules, and the trapper material can be disposed in foam separators between the cells in each module. Alternatively or in addition, trapper material can be disposed in a layer in the bottom of the disclosure, under the plurality of battery cells. Alternatively, or in addition the trapper material can be disposed in spaces in the enclosure not occupied by battery cells. Alternatively, or in addition the trapper material can be disposed in on the exterior of the battery cells.

### BRIEF DESCRIPTION OF THE DRAWINGS

The present disclosure will become more fully understood from the detailed description and the accompanying drawings, wherein:

FIG. 1 is an image of a battery pack showing the enclosure, and a plurality of modules each containing a plurality of battery cells, illustrating one type of battery pack into which the trapper materials of this disclosure can be applied;

FIG. 2 is a perspective view of one of the modules from the battery pack shown in FIG. 1;

FIG. 3 is a cross sectional view of the module, taken along the plane of line 3-3 in FIG. 2;

FIG. 4 is a schematic diagram of a trapper system deployable in a battery pack;

FIG. 5 is a graph of the gases produced inside a battery cell before and after exposure to a trapper according to this disclosure, showing the ability of the trapper to reduce the concentration of flammable volatile battery components; and

FIG. 6 is a graph of the gases produced inside a battery cell before and after exposure to a trapper according to this disclosure, showing the ability of the trapper to reduce the concentration of flammable volatile battery components.

### DETAILED DESCRIPTION

Embodiments of the present disclosure provide a vapor trapper for trapping flammable electrolyte vapor in a battery back, and in particular provide a battery pack with such a vapor trapper.

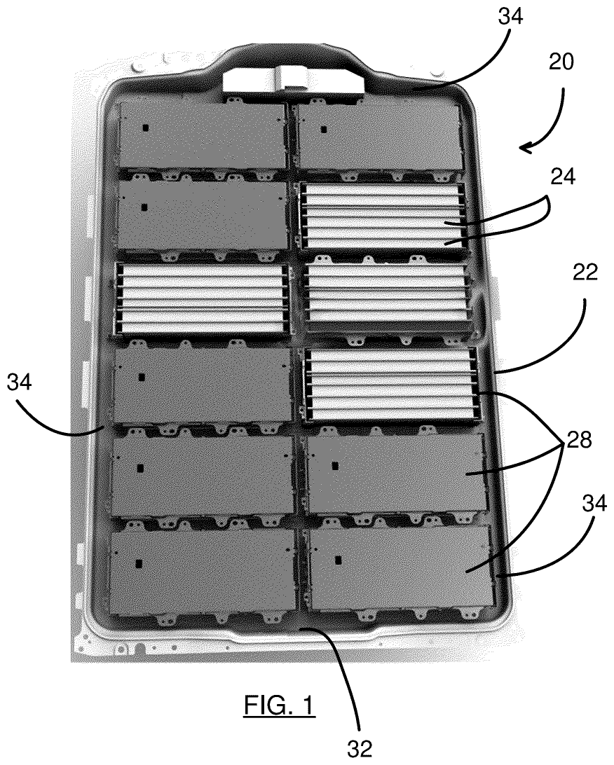

An improved battery pack according to a first embodiment of this disclosure, is indicated generally as 20 in FIG. 1. Battery pack 20 is of the type comprising an enclosure 22 containing a plurality of battery cells 24 having at least one flammable volatile electrolyte component. One example is the BEV 3 battery pack developed by General Motors Corporation, but this disclosure is not limited to this particular battery pack, and has applicability to any battery pack with cells that might leak volatile, flammable substances.

The improvement according to this embodiment comprises a trapper material capable of absorbing a volatile flammable electrolyte component that might leak from the battery cells 24 disposed inside the enclosure 22 of the battery pack 20.

The battery cells 24 may be any type of battery cell that employs a volatile, potentially flammable material, with any type of form factor, including but not limited to cylindrical cell form factors, prismatic cell form factors, and pouch cell form factors. The chemistry of each cell can be any chemistry that employs a volatile flammable component, whether as the anode, the cathode, or part of the electrolyte, including Lithium Iron Phosphate, Lithium Cobalt Oxide, Lithium Manganese Oxide, Lithium Nickel Manganese Cobalt Oxide, Lithium Nickel Cobalt Aluminum Oxide, Lithium Titanate cell systems. For example, Li/NCMA (nickel, cobalt, manganese, aluminum) cells can have electrolyte comprising fluoroethylene carbonate (FEC), dimethyl carbonate (DMC), and LiPF₆. Graphite/NCMA (nickel, cobalt, manganese, aluminum) cells can have an electrolyte comprising ethylene carbonate (EC), ethyl methyl carbonate (EMC), and LiPF₆.

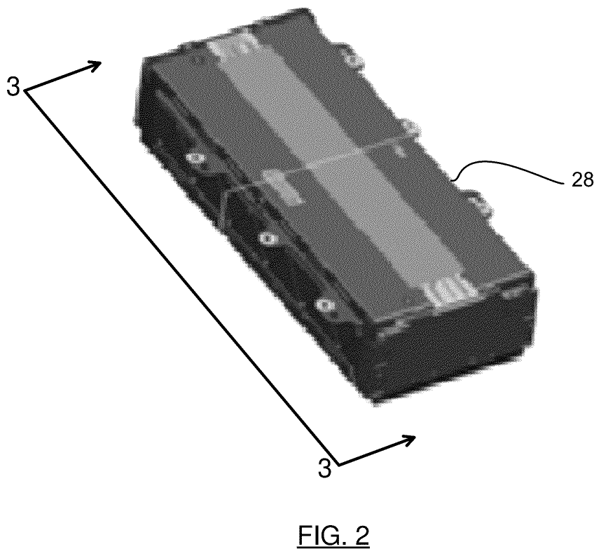

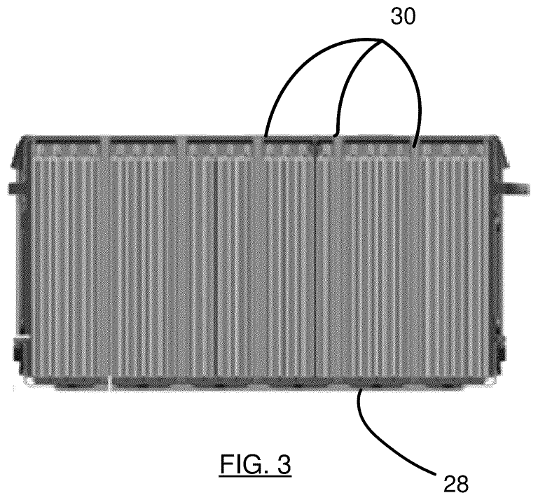

As shown in FIGS. 1 and 2, the cells 26 of the battery pack 20 may be arranged in a plurality of modules 28, and the trapper material can be disposed in foam separators 30 between the cells in each module. Alternatively, or in addition, trapper material can be disposed in a layer 32 in the bottom of the enclosure 22, under the plurality of battery cells 24. Alternatively, or in addition, the trapper material can be disposed in spaces 34 in the enclosure not occupied by battery cells. Alternatively, or in addition the trapper material can be disposed on the exterior of the battery cells 24, which as the advantage of providing trapper material in proportion to the amount of volatile, flammable material in the cells.

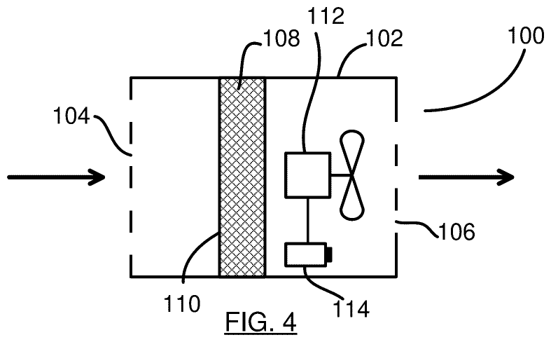

As shown in FIG. 4, trapper material can be provided to a battery back 20 with a trapper system 100, adapted to be disposed inside the battery pack enclosure 22, or outside the enclosure but in fluid communication with the interior of the enclosure. Trapper system 100 comprises a housing 102 with an inlet 104 and an outlet 106. The Trapper system 100 has a bed of trapper material 108 disposed in a trapper bed 110. The trapper system can have some means, such as fan 112, that circulates the atmosphere inside the enclosure 22 through the trapper bed 110. This fan 112 can be powered by an on-board battery 114, or it can be provided with thermoelectric generator, that uses the heat generated by the batteries to power the fan. Alternatively the fan 112 can be powered by the cells 24 in the battery pack 20.

The trapper material can comprise any of a variety of materials that absorb volatile, flammable substances, for example a hydrophobic, high surface (>40 m²/g) area thin (<5 mm) polyolefin film, such as polyethylene or polypropylene. The trapper material can alternatively or additionally comprise a hydrophobic zeolite, silica gel, activated alumina with high specific surface area (>40 m²/g) and decorated with hydrophobic functional groups, polarized polymeric resin that selectively adsorbs polar solvents; metal-organic frameworks (MOFs), clays, such as montmorillonite and bentonite, and/or or highly porous (50%-99%), high surface area (>40 m²/g) carbon-based adsorbent (graphitized carbon, carbon molecular sieves or activated carbon).

### Example 1

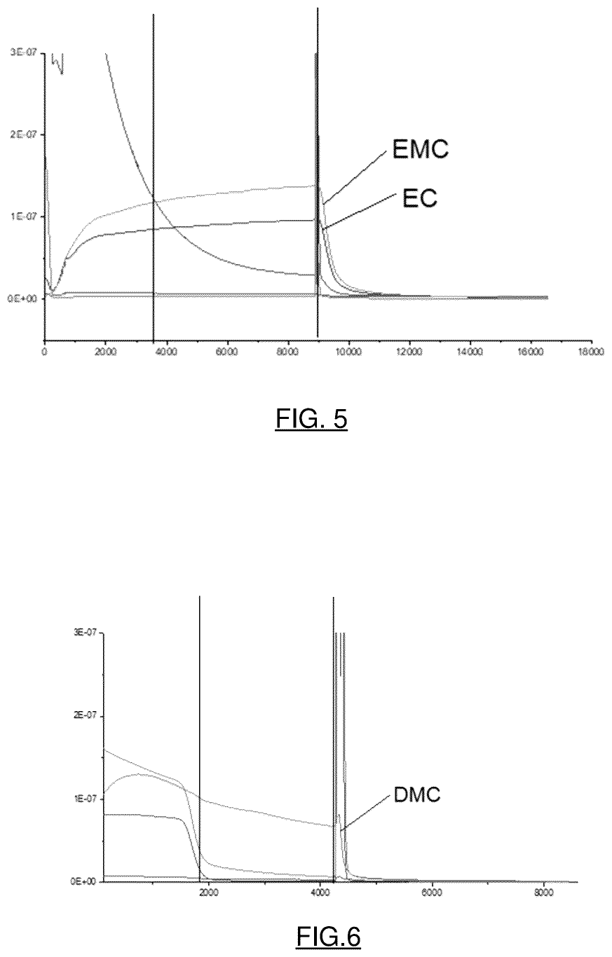

To validate the effect of a trapper in reducing volatile, flammable battery components, inlet and outlet ports were established in a 5 Ah graphite/NCMA cell with ethylene carbonate/ethyl methyl carbonate/LiPF₆ electrolyte. An inert carrier gas (Ar) was supplied to the cell via the inlet at 3 standard cubic centimeters per minute (sccm). The gas from the outlet port was analyzed, and the constituent gases using a gas chromatograph, and the results were graphed in the FIG. 5 graph. For approximately the first 3500 seconds, the gases in the cell were simply purged from the cell by the inert carrier gas. Thereafter the gases were collected and analyzed. Appreciable quantities of the volatile electrolyte solvent were present. At about 9000 seconds the gases from the outlet of the battery cell were exposed to trapper material, and the amount of ethylene carbonate and ethyl methyl carbonate in the gas from the battery cell outlet dropped significantly from 1.2E-8 mol/s to 0.08E-8 mol/s. This established that trapper materials can reduce the type of volatile flammable gases that might be generated in a battery pack, for example from a leak in a cell.

### Example 2

To validate the effect of a trapper in reducing volatile, flammable battery components, inlet and outlet ports were established in a 1 Ah Li/NCMA cell with fluoroethylene carbonate/dimethyl carbonate/LiPF₆ electrolyte. An inert carrier gas (Ar) was supplied to the cell via the inlet at 3 standard cubic centimeters per minute (sccm). The gas from the outlet port was analyzed, and the constituent gases using a gas chromatograph, and the results were graphed in the FIG. 6 graph. For approximately the first 1800 seconds, the gases in the cell were simply purged from the cell by the inert carrier gas. Thereafter the gases were collected and analyzed. Appreciable quantities of the volatile electrolyte solvents were present. At about 4200 seconds the gases from the outlet of the battery cell were exposed to trapper material, and the amount of dimethyl carbonate in the gas from the battery cell outlet dropped significantly from 0.8E-8 mol/s to 0.04E-8 mol/s. This established that trapper materials can reduce the type of volatile flammable gases that might be generated in a battery pack, for example from a leak in a cell.

### Operation

In operation a battery pack 22 is constructed from a plurality of battery cells 24 disposed in an enclosure 22. Trapper material as described in this disclosure is provided in the enclosure 22. This may be in the foam separators 30 between the cells 24 in modules in the enclosure. Alternatively, or in addition, the trapper material may be in a layer 32 in the bottom of the enclosure 22, under the plurality of battery cells 24. Alternatively, or in addition, the trapper material may be disposed in spaces 34 in the enclosure 22 not occupied by battery cells. Alternatively, or in addition the trapper material can be disposed on the exterior of the battery cells 24 themselves. Finally, the trapper material can be provided as part of a trapper system 100, adapted to be disposed inside the battery pack enclosure 22, or outside the enclosure but in fluid communication with the interior of the enclosure.

In the event of the leakage of volatile, flammable components from one or more of the cells 24 in the battery pack, the trapper material can absorb the volatile components, reducing the risk that the volatile, flammable components reach a concentration where they could catch fire or explode.

What is claimed is:

1. An improved battery pack of the type comprising an enclosure containing a plurality of battery cells having a flammable volatile electrolyte component, the improvement comprising a trapper material that absorbs the volatile flammable electrolyte component disposed inside the enclosure of the battery pack.

2. The improved battery pack according to claim 1 wherein the battery cells are arranged in a plurality of modules, and wherein the trapper material is disposed in foam separators between the cells in each module.

3. The improved battery pack according to claim 1 wherein the trapper material is disposed in a layer in the bottom of the disclosure, under the plurality of battery cells.

4. The improved battery pack according to claim 1 wherein the trapper material is disposed in spaces in the enclosure not occupied by battery cells.

5. The improved battery pack according to claim 1 wherein the trapper material is disposed in a trapper bed in a replaceable module that circulates atmosphere inside the enclosure through the trapper bed.

6. The improved batter pack according to claim 1 wherein the trapper material comprises a hydrophobic, high surface area greater than about 40 m²/g, thin polyolefin film less than about 5 mm thick.

7. The improved battery pack according to claim 6, wherein the polyolefin film is polyethylene or polypropylene.

8. The improved battery pack according to claim 1 wherein the trapper material comprises hydrophobic zeolite to preferentially.

9. The improved battery pack according to claim 1 wherein the trapper material comprises silica gel and activated alumina with high (greater than about 40 m²/g) specific surface area and decorated with hydrophobic functional groups.

10. The improved battery pack according to claim 1 wherein the trapper material comprises polarized polymeric resin that selectively adsorbs polar solvents.

11. The improved battery pack according to claim 1 wherein the trapper material comprises metal-organic frameworks (MOFs).

12. The improved battery pack according to claim 1 wherein the trapper material comprises clay.

13. The improved battery pack according to claim 12 wherein the clay comprises at least one of montmorillonite and bentonite.

14. The improved battery pack according to claim 1 wherein the trapper material comprises high surface area (>40 m²/g) carbon-based adsorbent (graphitized carbon, carbon molecular sieves or activated carbon).

15. The improved battery pack according to claim 1 wherein the batteries are Li/NCMA (nickel, cobalt, manganese, aluminum) cells with an electrolyte comprising fluoroethylene carbonate (FEC), dimethyl carbonate (DMC), and LiPF₆.

16. The improved battery pack according to claim 1 wherein the batteries are Graphite/NCMA (nickel, cobalt, manganese, aluminum) cells with an electrolyte comprising ethylene carbonate (EC), ethyl methyl carbonate (EMC), and LiPF₆.

17. A battery pack comprising:
an enclosure;
a plurality of battery cells having at least one flammable volatile electrolyte component;
a trapper material disposed in the enclosure that that absorbs the at least one volatile flammable electrolyte component from the batter cells. disposed inside the enclosure of the battery pack.

18. The improved battery pack according to claim 17 wherein the battery cells are arranged in a plurality of modules, and wherein the trapper material is disposed in foam separators between the cells in each module.

19. The improved battery pack according to claim 17 wherein the trapper material is disposed in a layer in the bottom of the disclosure, under the plurality of battery cells.

20. The improved battery pack according to claim 17 wherein the trapper material is disposed in a trapper bed in a replaceable module that circulates atmosphere inside the enclosure through the trapper bed.
